(19) United States
(12) Patent Application Publication
(10) Pub. No.: US 2013/0178226 A1
(43) Pub. Date: Jul. 11, 2013

(54) Method of Positioning Using Wireless Signals and Inertial Measurement Units, Electronic Device, and Positioning System Using the Same Method

(71) Applicant: Cywee Group Limited, Road Town (VG)

(72) Inventors: Zhou Ye, Foster City, CA (US); Shun-Nan Liou, Kaohsiung City (TW); Chin-Lung Lee, Taoyuan County (TW)

(73) Assignee: Cywee Group Limited, Road Town (VG)

(21) Appl. No.: 13/737,012

(22) Filed: Jan. 9, 2013

Related U.S. Application Data
(60) Provisional application No. 61/584,781, filed on Jan. 9, 2012.

(51) Int. Cl. H04W 64/00

(52) U.S. Cl. CPC H04W 64/00
USPC 455/456.1

(57) ABSTRACT

A method of positioning using wireless signals and an inertial measurement unit is provided. The method includes the following steps: providing a wireless signal strength data base, wherein the wireless signal strength database gathers a radio map and a plurality of wireless signal strength information corresponding to a plurality of orientations at all grid positions on the radio map; using the inertial measurement unit to detect a current orientation at a current position where the electronic device is located; detecting a current wireless signal strength information of the electronic device corresponding to the current orientation at the current position; and determining the current position according to the current orientation, the current wireless signal strength information, and the wireless signal strength data base.

### CROSS-REFERENCE TO RELATED APPLICATION

This application claims priority of U.S. Provisional Application No. 61/584,781, filed on Jan. 9, 2012.

### FIELD OF THE INVENTION

The present invention relates to positioning, and more particularly, to a method of positioning using wireless signals and an inertial measurement unit, an electronic device, and a positioning system using the same method.

### BACKGROUND OF THE INVENTION

As the IEEE 802.11 technology develops rapidly, wireless local area network (WLAN) in the world is gaining popularity day by day. Presently, indoor positioning technology can be used for determining the indoor location of an electronic device (such as, a mobile phone, a tablet PC, or a notebook) according to received signal strength index (RSSI) and location relationships. For example, when the RSSI is getting stronger, it means that the electronic device is near to the access point(s) (APs); when the RSSI is getting weaker, it means that the electronic device is far away from the APs. Generally speaking, there are usually several APs installed in an indoor positioning environment. That is to say, each AP at each position can collect a plurality of wireless signals so as to form a fingerprint, and the fingerprint at each position can be used for positioning.

Please refer to FIG. 1. FIG. 1 is a diagram illustrating the relationship between the position, the orientation of an electronic device, and the wireless signal strength. As shown in FIG. 1, a user is located at the same region, however, the orientations 101 and 102 of an electronic device 100 held in his hand are different. For example, the orientation 101 of the electronic device is facing towards the East, and the orientation 102 of the electronic device 100 is facing towards the West. Different orientations 101 and 102 of the same electronic device 100 at the same position contribute to different distances away from the AP 110, which obviously results in different wireless signal strengths. For this reason, there will be obvious errors existed if the positioning is performed according to wireless signal strengths only.

Hence, how to improve the accuracy of positioning in order to solve the above-mentioned problem has become an important topic in this field.

### SUMMARY OF THE INVENTION

It is therefore one of the objectives of the present invention to provide a method of positioning using wireless signals and an inertial measurement unit, an electronic device, and a positioning system using the same method to solve the above-mentioned problems in the prior art.

According to one aspect of the present invention, a method of positioning using wireless signals and an inertial measurement unit is provided. The method includes the following steps: providing a wireless signal strength data base, wherein the wireless signal strength database gathers a radio map and a plurality of wireless signal strength information corresponding to a plurality of orientations at all grid positions on the radio map; using the inertial measurement unit to detect a current orientation at a current position where the electronic device is located; detecting a current wireless signal strength information of the electronic device corresponding to the current orientation at the current position; and determining the current position according to the current orientation, the current wireless signal strength information, and the wireless signal strength data base.

According to another aspect of the present invention, an electronic device for positioning using wireless signals and an inertial measurement unit is provided. The electronic device includes an inertial measurement unit, a wireless signal strength detector, and a processor. The inertial measurement unit is arranged for detecting a current orientation at a current position where the electronic device is located. The wireless signal strength detector is arranged for detecting a current wireless signal strength information of the electronic device corresponding to the current orientation at the current position. The processor is arranged for determining the current position according to the current orientation, the current wireless signal strength information, and a wireless signal strength data base, wherein the wireless signal strength database gathers the radio map and a plurality of wireless signal strength information corresponding to a plurality of orientations at all grid positions on the radio map.

According to another aspect of the present invention, a positioning system for positioning using wireless signals and an inertial measurement unit is provided. The positioning system includes at least one access point, a server, and an electronic device. The at least one access point is arranged for transmitting at least one wireless signal. The server is arranged for providing a wireless signal strength data base, wherein the wireless signal strength database gathers a radio map and a plurality of wireless signal strength information corresponding to a plurality of orientations at all grid positions on the radio map. The electronic device includes an inertial measurement unit and a wireless signal strength detector. The inertial measurement unit is arranged for detecting a current orientation at a current position where the electronic device is located. The wireless signal strength detector is arranged for receiving the at least one wireless signal and detecting a current wireless signal strength information of the electronic device corresponding to the current orientation at the current position. The server determines the current position where the electronic device located according to the current orientation, the current wireless signal strength information, and the wireless signal strength data base.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating the relationship between the position, the orientation of an electronic device, and the wireless signal strength.

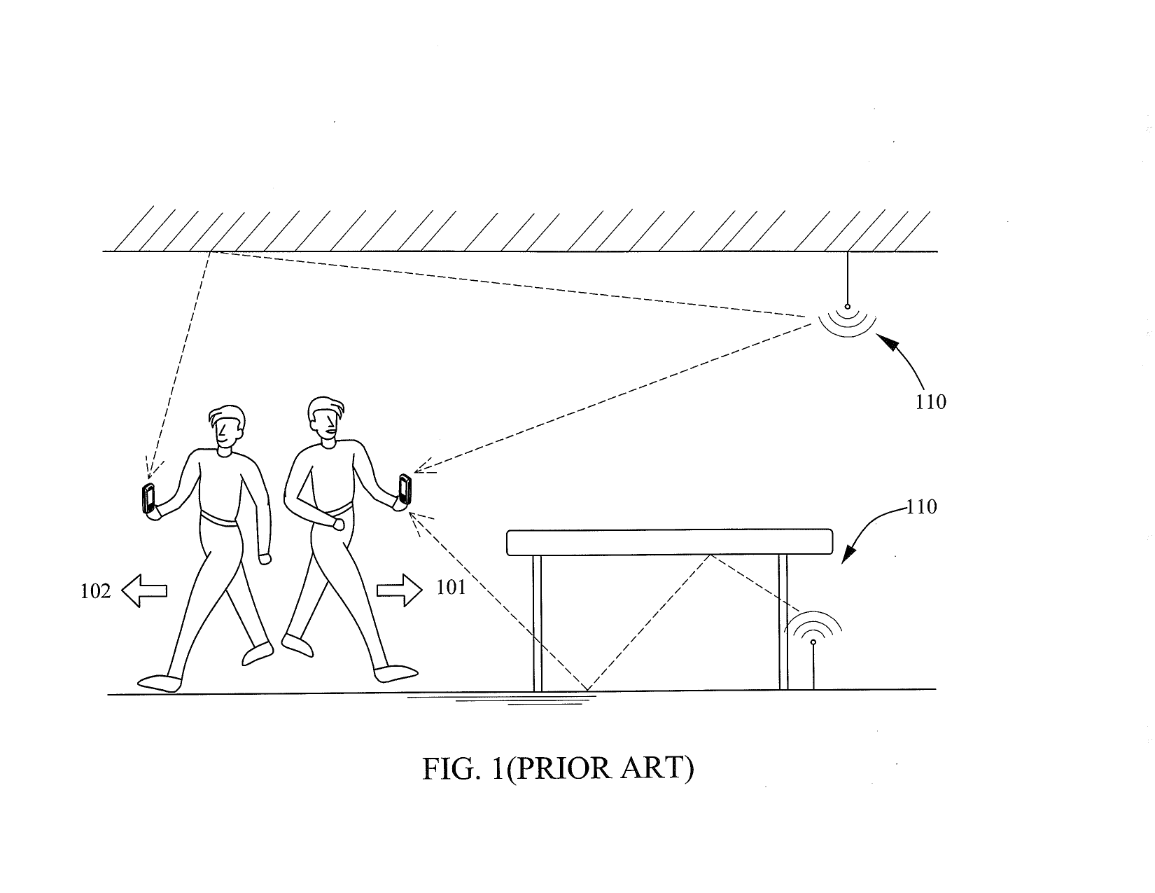

FIG. 2 is a diagram illustrating a positioning system for positioning using wireless signals and an inertial measurement unit according to an embodiment of the present invention.

FIG. 3 is a diagram illustrating how the positioning system performs indoor positioning according to an embodiment of the present invention.

FIG. 4 is a flowchart illustrating a method of positioning using wireless signals and an inertial measurement unit according to an exemplary embodiment of the present invention.

FIG. 5 is a flowchart illustrating a method of positioning using wireless signals and an inertial measurement unit according to another exemplary embodiment of the present invention.

### DETAILED DESCRIPTION OF THE INVENTION

Certain terms are used throughout the description and following claims to refer to particular components. As one skilled in the art will appreciate, manufacturers may refer to a component by different names. This document does not intend to distinguish between components that differ in name but not function. In the following description and in the claims, the terms “include” and “comprise” are used in an open-ended fashion, and thus should be interpreted to mean “include, but not limited to . . . ”.

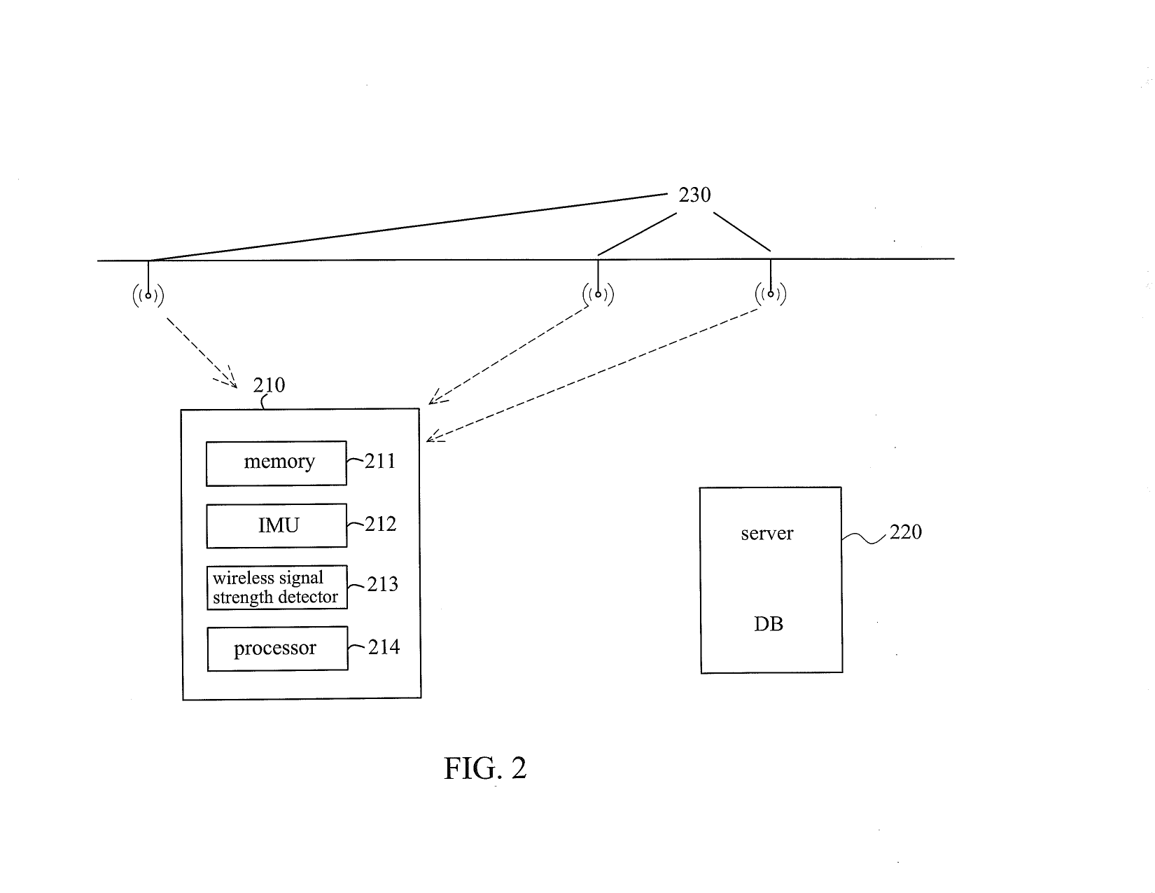

Please refer to FIG. 2. FIG. 2 is a diagram illustrating a positioning system 200 for positioning using wireless signals and an inertial measurement unit according to an embodiment of the present invention. As shown in FIG. 2, the positioning system 200 may include, but is not limited to, an electronic device 210, a server 220, and at least one access point (AP) 230. The at least one AP 230 is arranged for transmitting at least one wireless signal. The server 220 is arranged for providing a wireless signal strength data base DB, wherein the wireless signal strength database DB gathers a radio map RM and a plurality of wireless signal strength information RSSI1-RSSIN corresponding to a plurality of orientations at all grid positions GP on the radio map RM. The electronic device 210 may include, but is not limited to, a memory 211, an inertial measurement unit 212, a wireless signal strength detector 213, and a processor 214. The memory 211 is arranged for downloading and storing a copy of the wireless signal strength data base DB. The inertial measurement unit 212 is arranged for detecting a current orientation at a current position where the electronic device 210 is located. The wireless signal strength detector 213 is arranged for receiving the at least one wireless signal and detecting a current wireless signal strength information of the electronic device 210 corresponding to the current orientation at the current position. Be noted that, the current wireless signal strength information may include all MAC addresses (or IP addresses) and all the wireless signal strength information RSSI received from each of the at least one AP 230. The processor 214 is arranged for determining the current position according to the current orientation, the current wireless signal strength information, and a wireless signal strength data base, wherein the wireless signal strength database gathers the radio map and a plurality of wireless signal strength information corresponding to a plurality of orientations at all grid positions on the radio map. Be noted that, in one embodiment, the processor 214 may calculate the plurality of wireless signal strength information corresponding to the plurality of orientations at a plurality of grid positions on the radio map according to the current orientation so as to generate a plurality of calculated wireless signal strength information corresponding to the current orientation at the plurality of grid positions, and may compare the current wireless signal strength information with the calculated wireless signal strength information corresponding to the current orientation at the plurality of grid positions on the radio map so as to determine the current position. Please note that the plurality of grid positions comprise at least two grid positions that are closest to the current wireless signal strength information among all the grid positions.

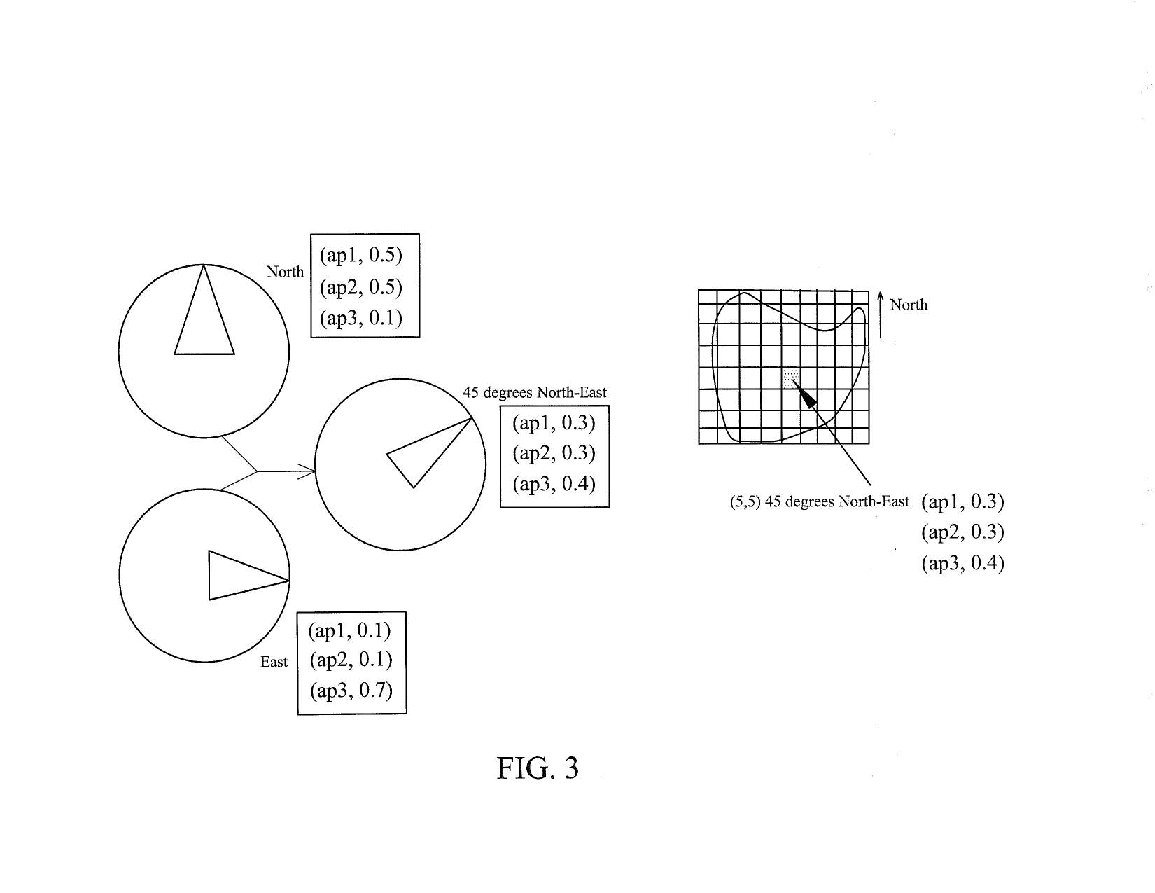

Please refer to FIG. 3. FIG. 3 is a diagram illustrating how the positioning system 200 performs indoor positioning according to an embodiment of the present invention. As shown in FIG. 3, when building up the wireless signal strength information database DB, a plurality of wireless signal strength information corresponding to a plurality of orientations at all grid positions on the radio map may be collected. For example, a plurality of wireless signal strength information corresponding to four orientations, including East, West, South, and North, at all grid positions on the radio map are collected. In one embodiment, the wireless signal strength information of all of the three access points AP1, AP2, and AP3 corresponding to the East orientation at the grid position coordinate (0,1) can be collected; the wireless signal strength information of all of the three access points AP1, AP2, AP3 corresponding to the West orientation at the grid position coordinate (0,1) can be collected; the wireless signal strength information of all of the three access points AP1, AP2, AP3 corresponding to the South orientation at the grid position coordinate (0,1) can be collected; and the wireless signal strength information of all of the three access points AP1, AP2, AP3 corresponding to the North orientation at the grid position coordinate (0,1) can be collected. Similarly, the wireless signal strength information of all of the three access points AP1, AP2, and AP3 corresponding to the East orientation at the grid position coordinate (0,2) can be collected; the wireless signal strength information of all of the three access points AP1, AP2, AP3 corresponding to the West orientation at the grid position coordinate (0,2) can be collected; the wireless signal strength information of all of the three access points AP1, AP2, AP3 corresponding to the South orientation at the grid position coordinate (0,2) can be collected; and the wireless signal strength information of all of the three access points AP1, AP2, AP3 corresponding to the North orientation at the grid position coordinate (0,2) can be collected, and so on. As a result, the wireless signal strength database DB can gather a plurality of wireless signal strength information of all access points corresponding to the four orientations, including East, West, South, and North, at all grid positions on the radio map, which can be indicated as (the grid position coordinate, the orientation, APn, RSSI). When a user is carrying the electronic device 210 in such an environment, the inertial measurement unit 212 can detect that the electronic device 210 is located in a current position CP with a current orientation of 45 degrees North-East, and the wireless signal strength detector 213 can detect a current wireless signal strength information from all access points, including (AP1, 0.3), (AP2, 0.3), and (AP3, 0.4), of the electronic device 210 corresponding to the current orientation at the current position CP. After that, the processor 214 may determine two closest orientations, i.e., the North and the East, among the plurality of orientations that is closest to the current orientation of 45 degrees North-East on a plurality of grid positions on the radio map. For example, the plurality of wireless signal strength information corresponding to the North orientation at the grid position coordinate (5, 5) include (API, 0.5), (AP2, 0.5), and (AP3, 0.1), and the plurality of wireless signal information corresponding to the East orientation at the grid position coordinate (5,5) include (AP1, 0.1), (AP2, 0.1), and (AP3, 0.7). Therefore, the processor 214 can use interpolation, but is not limited to, to generate the calculated wireless signal strength information (including (AP1, 0.3), (AP2, 0.3), and (AP3, 0.4)) corresponding to the current orientation of 45 degrees North-East at the grid position coordinate (5, 5) according to the plurality of wireless signal strength information corresponding to the two closest orientations (the North orientation and the East orientation). Similarly, the processor 214 may generate the calculated wireless signal strength information corresponding to the current orientation of 45 degrees North-East at all of the grid positions, and then the processor 214 may compare the current wireless signal strength information, including (AP1, 0.3), (AP2, 0.3), and (AP3, 0.4), with the calculated wireless signal strength information corresponding to the current orientation at all grid positions on the radio map so as to determine the current position CP as coordinate (5,5). In another embodiment of the present invention, the processor 214 may determine that the plurality of grid positions comprise at least two grid positions (i.e., the grid position coordinates (0,1) and (1,0)) that are closest to the current wireless signal strength information (including (AP1, 0.3), (AP2, 0.3), and (AP3, 0.4)) among all the grid positions. As a result, the processor 214 may generate the calculated wireless signal strength information corresponding to the current orientation of 45 degrees North-East at the grid position coordinates (0, 1) and (1,0). After that, the processor 214 may compare the current wireless signal strength information (i.e., (AP1, 0.3), (AP2, 0.3), and (AP3, 0.4)) with the calculated wireless signal strength information corresponding to the current orientation of 45 degrees North-East at the grid position coordinates (0, 1) and (1, 0) so as to determine that the current position CP is located between the grid position coordinate (0, 1) and the grid position coordinate (1,0).

Please note that, the abovementioned wireless signal strength data base DB can be stored either on the server 220 or on the electronic device 210. Those skilled in the art will easily appreciate the operations of the positioning system 200 after reading the abovementioned description, and further description is omitted here for brevity. Furthermore, the functions of the abovementioned processor 214 can be implemented by the server 220. That is, after the current grid position is determined by the server 220, the server 220 will transmit the determined current position CP to the electronic device 210 to be displayed.

As can be seen from the above, the wireless signal strength database DB of the present invention which gathers a plurality of wireless signal strength information corresponding to four orientations (including East, West, South, and North) at all grid positions is merely a practicable embodiment of the present invention, and in no way should be considered to be limitations of the scope of the present invention. Obviously, those skilled in the art should appreciate that various modifications of the wireless signal strength database DB may be made without departing from the spirit of the present invention. As an illustration, in one embodiment, the wireless signal strength database DB of the present invention can also be used for gathering the wireless signal strength information corresponding to two or three of the four orientations (including East, West, South, and North) at all grid positions; in another embodiment, the wireless signal strength database DB of the present invention can be used for gathering the wireless signal strength information corresponding to three orientations having an induced angle of 120 degree between each other, which also belongs to the scope of the present invention.

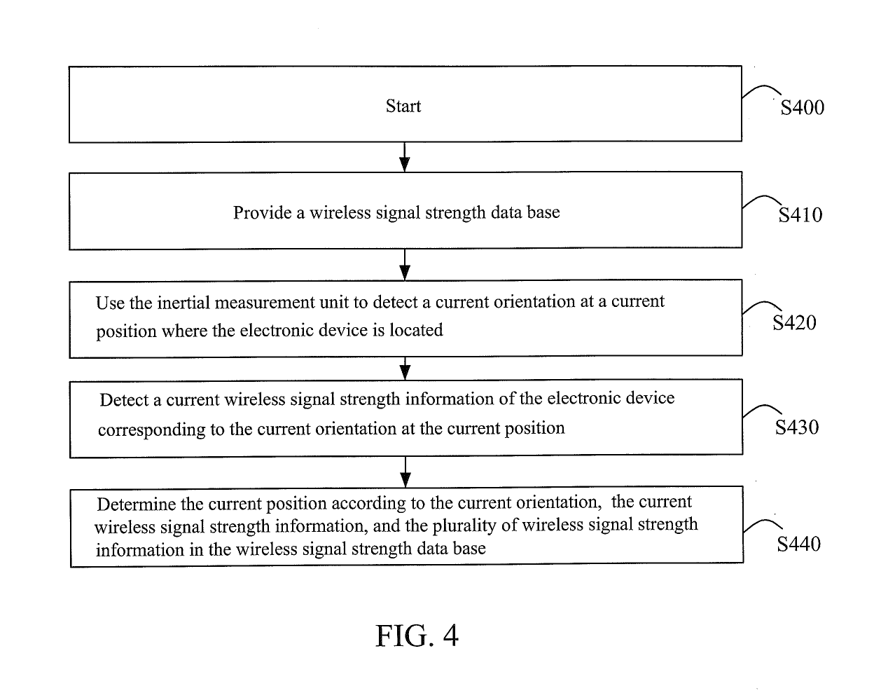

Please refer to FIG. 4. FIG. 4 is a flowchart illustrating a method of positioning using wireless signals and an inertial measurement unit according to an exemplary embodiment of the present invention. Please note that the following steps are not limited to be performed according to the exact sequence shown in FIG. 4 if a roughly identical result can be obtained. The method includes, but is not limited to, the following steps:

Step S400: Start.

Step S410: Provide a wireless signal strength data base, wherein the wireless signal strength database gathers a radio map and a plurality of wireless signal strength information corresponding to a plurality of orientations at all grid positions on the radio map.

Step S420: Use the inertial measurement unit to detect a current orientation at a current position where the electronic device is located.

Step S430: Detect a current wireless signal strength information of the electronic device corresponding to the current orientation at the current position.

Step S440: Determine the current position according to the current orientation, the current wireless signal strength information, and the plurality of wireless signal strength information in the wireless signal strength data base.

Those skilled in the art can readily understand how each element operates by combining the steps shown in FIG. 4 and the elements shown in FIG. 2, and further description is omitted here for brevity. In one embodiment, the step S420 is executed by the inertial measurement unit 212, and the step S430 is executed by the wireless signal strength detector 213, and the step S440 is executed by the processor 214.

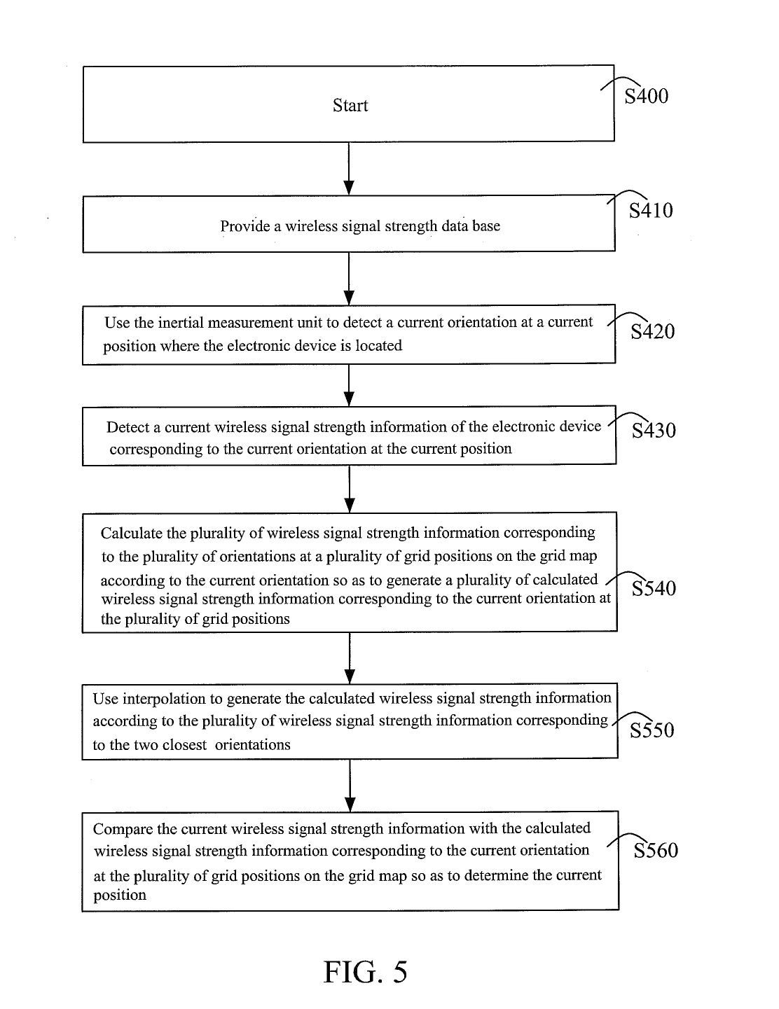

Please refer to FIG. 5. FIG. 5 is a flowchart illustrating a method of positioning using wireless signals and an inertial measurement unit according to another exemplary embodiment of the present invention. Please note that the following steps are not limited to be performed according to the exact sequence shown in FIG. 5 if a roughly identical result can be obtained. The method includes, but is not limited to, the following steps:

Step S400: Start.

Step S410: Provide a wireless signal strength data base, wherein the wireless signal strength database gathers a radio map and a plurality of wireless signal strength information corresponding to a plurality of orientations at all grid positions on the radio map.

Step S420: Use the inertial measurement unit to detect a current orientation at a current position where the electronic device is located.

Step S430: Detect a current wireless signal strength information of the electronic device corresponding to the current orientation at the current position.

Step S540: Calculate the plurality of wireless signal strength information corresponding to the plurality of orientations at a plurality of grid positions on the radio map according to the current orientation so as to generate a plurality of calculated wireless signal strength information corresponding to the current orientation at the plurality of grid positions.

S550: Use interpolation to generate the calculated wireless signal strength information according to the plurality of wireless signal strength information corresponding to the two closest orientations.

S560: Compare the current wireless signal strength information with the calculated wireless signal strength information corresponding to the current orientation at the plurality of grid positions on the radio map so as to determine the current position.

Those skilled in the art can readily understand how each element operates by combining the steps shown in FIG. 5 and the elements shown in FIG. 2-FIG. 3, and further description is omitted here for brevity. In this embodiment, the step S420 is executed by the inertial measurement unit 212, and the step S430 is executed by the wireless signal strength detector 213, and the step S540-S560 can be executed by the processor 214 or the server 220.

The abovementioned embodiments are presented merely to illustrate practicable designs of the present invention, and should be considered to be limitations of the scope of the present invention. In summary, the wireless signal strength database DB can be further adjusted according to the current orientation at the current position where the electronic device 210 is located, which can make positioning more accurate.

Those skilled in the art will readily observe that numerous modifications and alterations of the device and method may be made while retaining the teachings of the invention.

What is claimed is:

1. A method of positioning using wireless signals and an inertial measurement unit, comprising:
providing a wireless signal strength data base, wherein the wireless signal strength database gathers a radio map and a plurality of wireless signal strength information corresponding to a plurality of orientations at all grid positions on the radio map;
using the inertial measurement unit to detect a current orientation at a current position where the electronic device is located;
detecting a current wireless signal strength information of the electronic device corresponding to the current orientation at the current position; and
determining the current position according to the current orientation, the current wireless signal strength information, and the wireless signal strength data base.

2. The method of claim 1, wherein the step of determining the current position according to the current orientation, the current wireless signal strength information, and the wireless signal strength data base comprises:
calculating the plurality of wireless signal strength information corresponding to the plurality of orientations at a plurality of grid positions on the radio map according to the current orientation so as to generate a plurality of calculated wireless signal strength information corresponding to the current orientation at the plurality of grid positions, wherein the plurality of grid positions comprise at least two grid positions that are closest to the current wireless signal strength information among all the grid positions; and
comparing the current wireless signal strength information with the calculated wireless signal strength information corresponding to the current orientation at the plurality of grid positions on the radio map so as to determine the current position.

3. The method of claim 2, wherein the step of calculating the plurality of wireless signal strength information corresponding to the plurality of orientations at the plurality of grid positions on the radio map according to the current orientation so as to generate the plurality of calculated wireless signal strength information corresponding to the current orientation at all grid positions comprises:
determining two closest orientations among the plurality of orientations that is closest to the current orientation on the plurality of grid positions ; and
using interpolation to generate the calculated wireless signal strength information according to the plurality of wireless signal strength information corresponding to the two closest orientations.

4. The method of claim 1, wherein the wireless signal strength database gathers a plurality of wireless signal strength information corresponding to four orientations at all grid positions, and the four orientations comprises East, West, South, and North.

5. An electronic device for positioning using wireless signals and an inertial measurement unit, comprising:
an inertial measurement unit, detecting a current orientation at a current position where the electronic device is located;
a wireless signal strength detector, detecting a current wireless signal strength information of the electronic device corresponding to the current orientation at the current position; and
a processor, determining the current position according to the current orientation, the current wireless signal strength information, and a wireless signal strength data base, wherein the wireless signal strength database gathers the radio map and a plurality of wireless signal strength information corresponding to a plurality of orientations at all grid positions on the radio map.

6. The electronic device of claim 5, wherein the processor is further arranged for:
calculating the plurality of wireless signal strength information corresponding to the plurality of orientations at a plurality of grid positions on the radio map according to the current orientation so as to generate a plurality of calculated wireless signal strength information corresponding to the current orientation at the plurality of grid positions ,wherein the plurality of grid positions comprise at least two grid positions that are closest to the current wireless signal strength information among all the grid positions; and
comparing the current wireless signal strength information with the calculated wireless signal strength information corresponding to the current orientation at the plurality of grid positions on the radio map so as to determine the current position.

7. The electronic device of claim 6, wherein the processor is further arranged for:
determining two closest orientations among the plurality of orientations that is closest to the current orientation on the plurality of grid positions; and
using interpolation to generate the calculated wireless signal strength information according to the plurality of wireless signal strength information corresponding to the two closest orientations.

8. The electronic device of claim 5, wherein the wireless signal strength database gathers a plurality of wireless signal strength information corresponding to four orientations at all grid positions, and the four orientations comprises East, West, South, and North.

9. The electronic device of claim 5, further comprising:
a memory, storing a copy of the wireless signal strength data base, wherein the wireless signal strength database gathers the radio map and a plurality of wireless signal strength information corresponding to a plurality of orientations at all grid positions on the radio map.

10. A positioning system for positioning using wireless signals and an inertial measurement unit, comprising:
at least one access point, transmitting at least one wireless signal;
a server, providing a wireless signal strength data base, wherein the wireless signal strength database gathers a radio map and a plurality of wireless signal strength information corresponding to a plurality of orientations at all grid positions on the radio map; and
an electronic device, comprising:
an inertial measurement unit, detecting a current orientation at a current position where the electronic device is located; and
a wireless signal strength detector, receiving the at least one wireless signal and detecting a current wireless signal strength information of the electronic device corresponding to the current orientation at the current position;
wherein the server determines the current position where the electronic device located according to the current orientation, the current wireless signal strength information, and the wireless signal strength data base.
